(19) United States
(12) Patent Application Publication
(10) Pub. No.: US 2006/0226935 A1
(43) Pub. Date: Oct. 12, 2006

(54) Electromagnetic relay

(76) Inventors: Hiroyuki Kon, Iwate (JP); Masayuki Morimoto, Iwate (JP)

Correspondence Address: WHITHAM, CURTIS & CHRISTOFFERSON, P.C., Suite 340, 11491 Sunset Hills Road, Reston, VA, 20190, US

(21) Appl. No.: 11/401,347

(22) Filed: Apr. 11, 2006

(30) Foreign Application Priority Data
Apr. 12, 2005 (JP) 2005-114584

(51) Int. Cl. H01H 51/22

(52) U.S. Cl. 335/78

(57) ABSTRACT

An electromagnetic relay is provided which is capable of reducing a contact bounce at time of closing a contact. The electromagnetic relay is so configured that an opposed angle θ is 0°<θ<45°, when viewed from a direction to which a normally open fixed contact and a movable contact slide before the normally open fixed contact comes into surface-contact with the movable contact spring.

### BACKGROUND OF THE INVENTION

1. Field of the Invention

The present invention relates to an electromagnetic relay and more particularly to the electromagnetic relay to be used as a vehicle-mounted electromagnetic relay or a like.

The present application claims priority of Japanese Patent Application No. 2005-114584 filed on Apr. 12, 2005, which is hereby incorporated by reference.

2. Description of the Related Art

Conventionally, an electromagnetic relay is used for electrical components of automobiles or a like. The general and conventional electromagnetic relay being used as a vehicle-mounted one is described below.

FIG. 1 is a perspective view showing configurations of a conventional electromagnetic relay 10. FIG. 2 is partially exploded perspective view showing configurations of the conventional electromagnetic relay 10 of FIG. 1. FIG. 3 is a partial side view showing configurations of the conventional electromagnetic relay 10 of FIG. 1. As shown in FIG. 1, on a base 7 is mounted a coil 1 on which a movable contact 3a is placed with a yoke 2 and an armature 4 being interposed between the coil 1 and movable contact 3a. As shown in FIG. 2, the electromagnetic relay 10 operates in a manner in which an end of its movable contact spring 3 serves as the movable contact 3a which alternately comes in contact with a normally closed fixed contact 5a of a normally closed fixed contact member 5 placed so as to face the movable contact 3a and a normally open fixed contact 6a of a normally open fixed contact member 6 also placed so as to face the movable contact 3a.

Moreover, the movable contact spring 3 is in contact with the armature 4 with a spool 8 and an iron core 9 being interposed between the movable contact spring 3 and the armature 4.

In FIGS. 1 to 3, when a voltage is applied to the coil 1, the movable contact spring 3 and the movable contact 3a move toward a direction A (FIG. 3) and, when striking the normally open fixed contact 6a to come into physical contact on surfaces of the movable contact 3a and the normally open fixed contact 6a, the movable contact spring 3 bends with attractive forces of magnetic and the movable contact 3a slides on the normally open fixed contact 6a toward a direction B (FIG. 3).

FIGS. 8A and 8B are partial side views explaining operations of the movable contact 3a, normally closed fixed contact 5a, and normally open fixed contact 6a when viewed from a direction to which the contact slides (same as the direction B in FIG. 3) in the conventional electromagnetic relay 10. FIG. 8A shows operations in a non-excited state and FIG. 8B shows operations in an excited state. As shown in FIG. 8A, in the conventional electromagnetic relay 10, when a voltage is applied to its coil 1 shown in FIGS. 1 and 2, the movable contact 3a strikes the normally open fixed contact 6a and slides thereon. An angle which a surface of the movable contact 3a being opposed to the normally open fixed contact 6a, when viewed from the direction to which the movable contact 3a slides on the normally open fixed contact 6a, forms with a surface of the normally open fixed contact 6a being opposed to the surface of the movable contact 3a when viewed from the sliding direction is set to be fixed so that the movable contact 3a is parallel to the normally open fixed contact 6a. As shown in FIG. 8B, when an voltage is applied to the coil 1 (as shown in FIGS. 1 and 2), the movable contact 3a comes into collision with the normally open fixed contact 6a and the movable contact 3a is moved by repulsion in a manner to become a movable contact 11 shown by dashed lines which is the movable contact 3a resulting from the movement. This movement is called a “contact bounce”.

Generally, a very large amount of current flows through loads such as a lamp or a capacitor when a contact is closed. Therefore, the above-described contact bounce occurring at the time of closing the contact has much effect on a contact life of the electromagnetic relay 10.

If a contact bounce occurs in a state where a large amount of current is flowing, arc currents are produced and there is a danger of an occurrence of a failure such as welding of a contact or locking caused by a protrusion or hole formed on a contact surface.

In order to decrease the occurrence of the bounce at time of closing the contact, by making stiffness of the fixed contact member be lowered and by making the fixed contact member itself have elasticity, repulsion is suppressed at a time of collision of the movable contact, which enables the occurrence of the bounce to be reduced. This technology is disclosed in Patent Reference 1 (Japanese Utility Model Application Laid-open No. Hei05-83994).

As described above, in the Patent Reference 1, for example, in order to decrease the occurrence of arc currents, an electromagnetic relay is so configured that a fixed contact spring itself is made to have elasticity, however, to make the fixed contact member itself have elasticity, it is necessary to make a plate thickness be small, which causes a decrease in current-carrying capability due to reduction in a cross-sectional area for current carrying. Moreover, if a vibration-isolating material is to be mounted thereon, new problems of an increase in component counts accompanied by an increase in the number of man-hours or in costs arise.

### SUMMARY OF THE INVENTION

In view of the above, it is an object of the present invention to provide an electromagnetic relay which is capable of reliably decreasing a contact bounce at time of closing a contact without causing a decrease in current-carrying capability and an increase in component counts.

According to a first aspect of the present invention, there is provided an electromagnetic relay including:

a fixed contact member having a normally closed fixed contact;

a fixed contact member having a normally open fixed contact;

a movable contact spring having a movable contact whose surface is opposed to each of a surface of the normally closed fixed contact and a surface of the normally open fixed contact;

an armature coupled to the movable contact spring; and

an iron core around which coils used to attract the armature are wound;

wherein, by interaction between a spring force of the movable contact and a magnetic force generated by an exciting current fed to the coils, either of the normally closed fixed contact or the normally open fixed contact does or does not come into surface-contact with the movable contact and wherein an opposed angle θ when viewed from a direction of sliding of the movable contact and the normally open fixed contact that is induced by bending of the normal contact spring, which the normally open fixed contact forms with the movable contact before either of the normal close contact or the normal open contact comes into surface-contact with the movable contact, is 0°<θ<45°.

In the foregoing aspect, a preferable mode is one wherein the opposed angle θ, when viewed from the direction of sliding of the movable contact and the normally open fixed contact that is induced by bending of the normal contact spring, which the normally open fixed contact forms with the movable contact before either of the normal close contact or the normal open contact comes into surface-contact with the movable contact, is 0°<0<20°.

Also, a preferable mode is one wherein the normally open fixed contact has a plate-shaped surface, and the movable contact has a plate-shaped surface.

Another preferable mode is one wherein the normally open fixed contact is formed to have an inclination angle θ being equal to the opposed angle θ in advance, such that the opposed angle θ, when viewed from the direction of sliding of the movable contact and the normally open fixed contact that is induced by bending of the normal contact spring, which the normally open fixed contact forms with the movable contact before either of the normal close contact or the normal open contact comes into surface-contact with the movable contact, is 0°<θ<45°.

Still another mode is one wherein the movable contact is formed to have an inclination angle θ being equal to the opposed angle θ in advance, such that the opposed angle θ, when viewed from the direction of sliding of the movable contact and the normally open fixed contact that is induced by bending of the normal contact spring, which the normally open fixed contact forms with the movable contact before either of the normal close contact or the normal open contact comes into surface-contact with the movable contact, is 0°<θ<45°.

By configuring as above, the surface of the plate-shaped normally open fixed contact and the surface of the plate-shaped movable contact are opposed to each other in a manner to form a specified angle and, when the normally open fixed contact comes into surface-contact with the movable contact, after part of one contact portion comes into contact with part of other contact portion, the movable contact is twisted, while sliding on the plate-shaped movable contact due to elasticity of an arm-shaped spring member supporting the movable contact, which causes a residual portion of the contact to come into contact and causes repulsion at a time of collision to be reduced, thus preventing an occurrence of a contact bounce.

With the above configuration, the contact bounce at the time of closing the contact is reduced, which enables the provision of the electromagnetic relay to have a long contact life.

### BRIEF DESCRIPTION OF THE DRAWINGS

The above and other objects, advantages, and features of the present invention will be more apparent from the following description taken in conjunction with the accompanying drawings in which:

FIG. 1 is a perspective view showing configurations of a conventional electromagnetic relay;

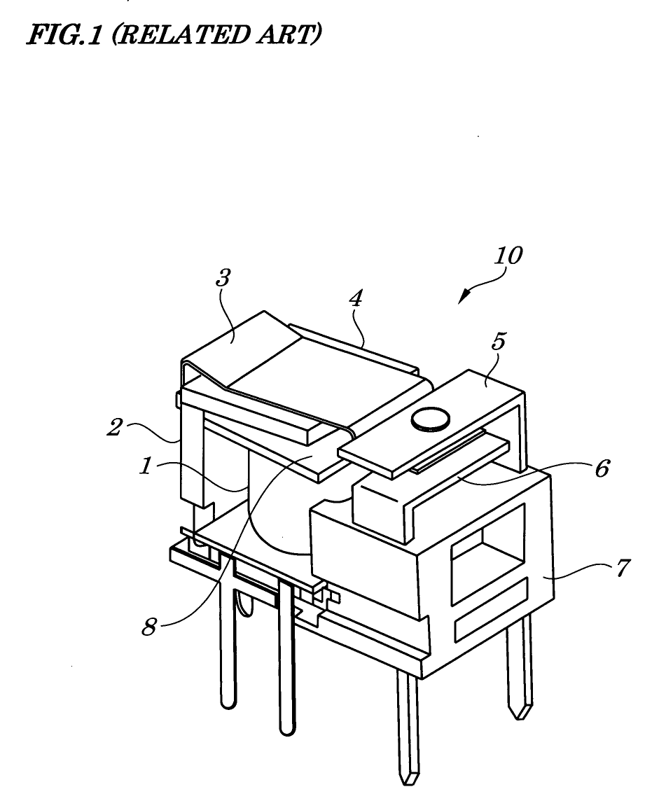

FIG. 2 is a partially exploded perspective view showing configurations of the conventional electromagnetic relay of FIG. 1;

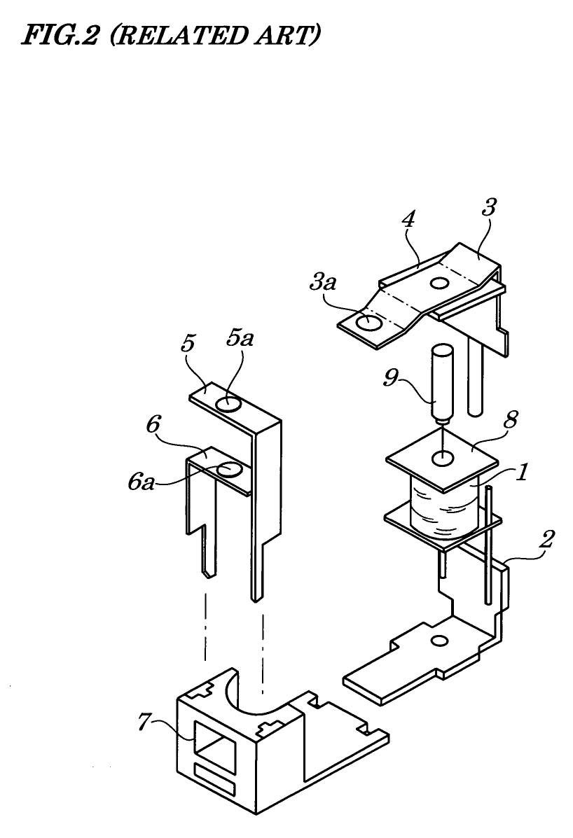

FIG. 3 is a partial side view showing configurations of the conventional electromagnetic relay of FIG. 1;

FIG. 4 is a partial side view showing configurations of the electromagnetic relay according to a first embodiment of the present invention;

FIG. 5 is a partial side view showing configurations of an electromagnetic relay according to a second embodiment of the present invention;

FIG. 6 is a partial side view showing configurations of an electromagnetic relay according to a third embodiment of the present invention;

FIG. 7 is a schematic diagram showing an electric circuit to be used in an electrical life test under lamp-loaded conditions on the electromagnetic relay according to the first embodiment of the present invention;

FIGS. 8A and 8B are partial side diagrams showing the conventional electromagnetic relay; and FIG. 8A shows a non-excited state and FIG. 8B shows an excited state;

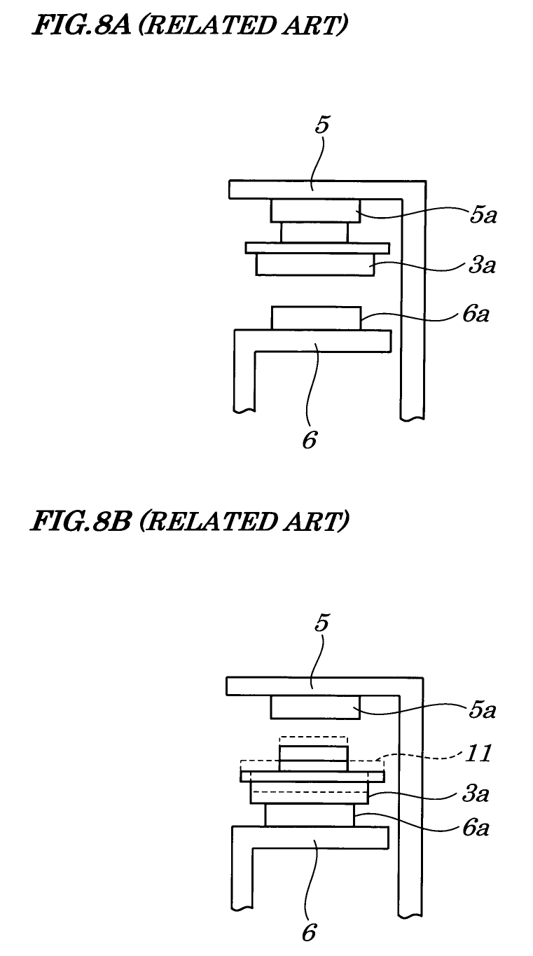

### DETAILED DESCRIPTION OF THE PREFERRED EMBODIMENTS

Best modes of carrying out the present invention will be described in further detail using various embodiments with reference to the accompanying drawings. According to the present invention, an inclination angle θ which a surface of a movable contact forms with a surface of a normally open fixed contact obtained by making a supporter of at least either of the movable contact or the normally open fixed contact be inclined in advance is preferably 0°<θ<45°. Also, the same effect as above can be achieved not by making the supporter be inclined, but by making the contact portion only be inclined so as to have a convex surface. Moreover, the reason why the inclination angle θ is set in the above range is that, if the inclination angle θ is more than 45°, a contact failure occurs. From a viewpoint of wearing-out of the contact, the inclination angle θ is set to be preferably 5°<θ<20°.

### First Embodiment

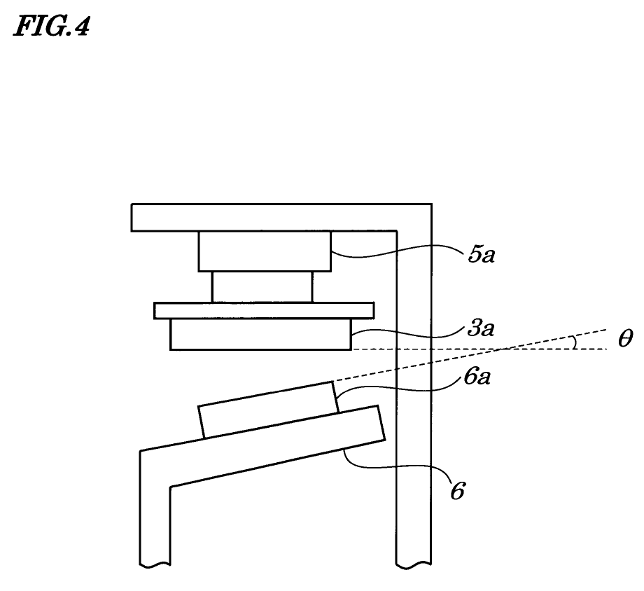

FIG. 4 is a side view of a contact portion when viewed from a direction to which a movable contact 3a slides on a normally open fixed contact 6a according to the first embodiment of the present invention. A normally open fixed contact 6a is inclined and an inclination angle θ is formed by a surface of the movable contact 3a and by a surface of the normally open fixed contact 6a. When a voltage is applied to a coil, the surface of the inclined normally open fixed contact 6a strikes the surface of the movable contact 3a to come into physical contact. At this time point, a movable contact spring 3 bends with attractive forces of magnetic, which causes the movable contact 3a and the normally open fixed contact 6a to slide relatively on each other, and which the movable contact 3a is attracted to the normally open fixed contact 6a.

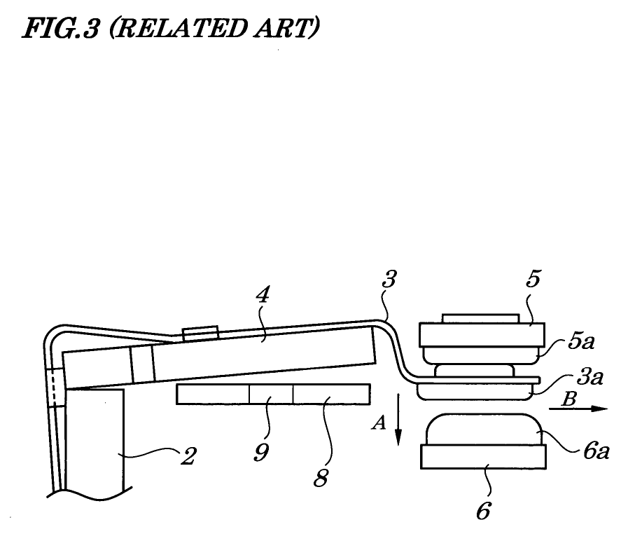

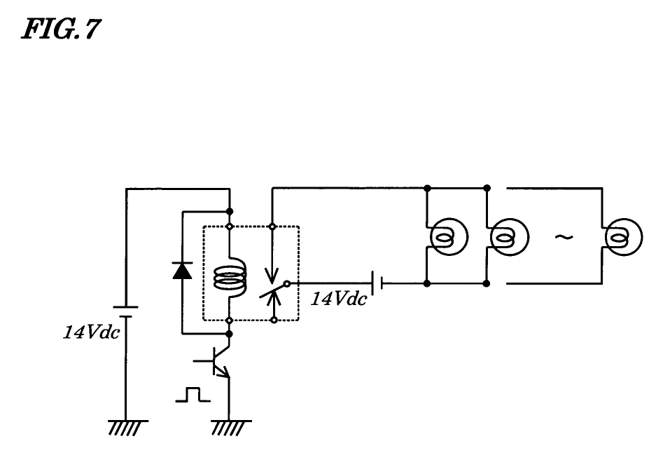

An electrical life test under lamp-loaded conditions was conducted, using a testing circuit shown in FIG. 7, on an electromagnetic relay having its contact configurations shown in FIG. 4 that was used as a test sample. The inclination angle θ which the surface of the movable contact 3a forms with the surface of the normally open fixed contact 6a was changed at every 5° from a level of θ=5° (test sample 2) to a level of θ=45° (test sample 10). Ten test samples for each of the above inclination angle levels were prepared. Moreover, for comparison, another electrical life test was conducted, using the same circuit as used in the above test, on a test sample 1 having the conventional contact structure shown in FIG. 3, that is, having its inclination angle θ=0° of a normally open fixed contact 6a. In this life test, both a coil voltage and a lamp-loaded voltage were 14 Vdc and the test was conducted in ordinary temperature environments and initial bounce time and the number of times of operations performed before an occurrence of failure were measured to obtain mean values.

Table 1 shows results from the electrical life test.

TABLE 1
Results from Opposed-angle Level Based Life Test

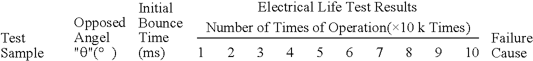

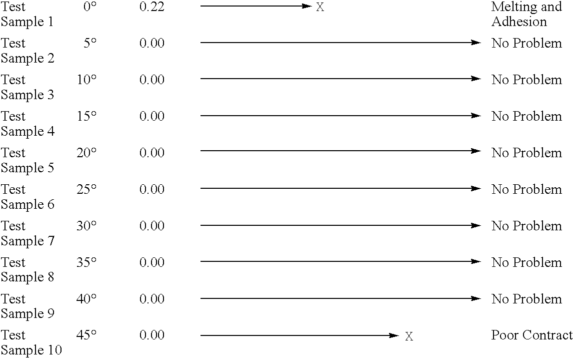

As shown in Table 1, the comparison between the conventional example (test sample 1) and samples (test samples 2 to 9) according to the first embodiment of the present invention shows that an initial bounce occurs and the electrical life was only about forty-thousand operations in the conventional example (test sample 1), whereas no initial bounce occurred in the test samples 2 to 9 according to the first embodiment of the present invention. Moreover, even if the number of times of operations exceeds one hundred thousand, no failure occurred. It is assumed that the occurrence of arc currents at the time of closing the contact can be prevented with the configurations of the first embodiment. Also, in the case of the test sample 10, in which the inclination angle θ=45°, though the initial bounce did not occur, when the number of times of operations exceeds seventy-thousand, a failure occurred. This was presumably attributable to a contact failure caused by excessive inclination of the normally open fixed contact 6a.

Though not shown in Table 1, when the test samples 2 to 9 were made to operate in a manner to exceed one hundred thousand times of operations, the test samples 2 to 5 showed excellent results in particular. This is presumably not only because the occurrence of arc currents caused by the bounce at time of operations was prevented but also because wearing-out of the contact caused by the occurrence of the arc currents at time of restoration was decreased. Therefore, when the inclination angle θ is more than 0° and is less than 45°, the occurrence of the initial bounce is prevented and the electromagnetic relay having an electrically long life can be obtained. The inclination angle θ is more preferably set to be more than 5° and 20° or less.

### Second Embodiment

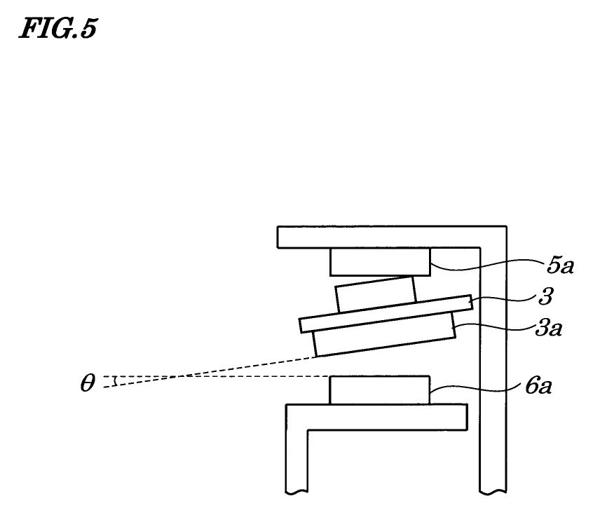

FIG. 5 is a diagram showing a side face of a contact portion when viewed from a direction to which a movable contact 3a slides on a normally open fixed contact 6a according to the second embodiment of the present invention. The movable contact 3a is inclined and an inclination angle θ is formed by a surface of the movable contact 3a and by a surface of a normally open fixed contact 6a. When a voltage is applied to a coil (not shown), the surface of the inclined movable contact 3a strikes the surface of the normally open fixed contact 6a to come into physical contact. At this time point, a movable contact spring 3 bends with attractive forces of magnetic, which causes the movable contact 3a to slide on the normally open fixed contact 6a, and which the movable contact 3a is attracted to the normally open fixed contact 6a.

An electrical life test under lamp-loaded conditions was conducted, using a testing circuit shown in FIG. 7, on the electromagnetic relay having its contact configurations shown in FIG. 5 that was used as a test sample. An inclination angle θ which the surface of the movable contact 3a forms with the surface of the normally open fixed contact 6a was changed at every 5° from a level of θ=5° (test sample 2) to a level of θ=45° (test sample 10). Ten test samples for each of the above inclination angle levels were prepared. Moreover, for comparison, another electrical life test was conducted, using the same circuit as used in the above test, on a test sample 1 having a conventional contact structure shown in FIG. 3, that is, having its inclination angle θ=0° of the normally open fixed contact 6a. In this life test, both a coil voltage and a lamp-loaded voltage were 14 Vdc and the test was conducted in ordinary temperature environments and initial bounce time and the number of times of operations performed before an occurrence of failure were measured to obtain mean values.

As a result, almost the same effect obtained in the first embodiment was achieved in the second embodiment. Therefore, when the angle θ which the surface of the movable point 3a forms with the surface of the normally open fixed contact 6a is more than 0° and is less than 45°, occurrence of an initial bounce is prevented and the electromagnetic relay having an electrically long life can be obtained. The inclination angle θ is more preferably set to be more than 5° and 20° or less.

### Third Embodiment

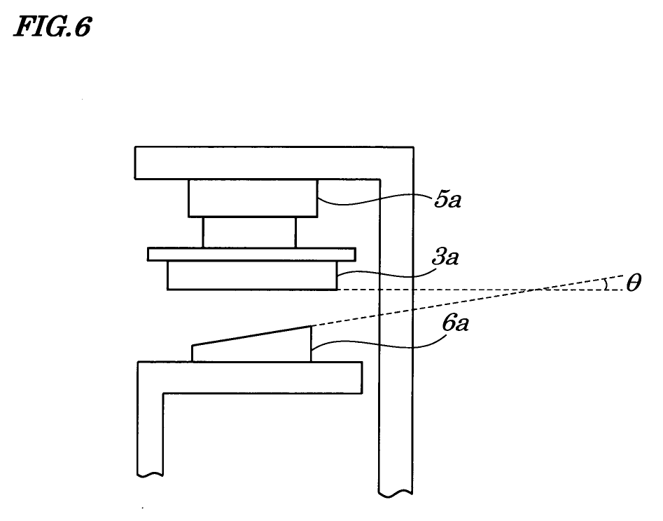

FIG. 6 is a diagram showing a side face of a contact portion when viewed from a direction to which a movable contact 3a slides on a normally open fixed contact 6a according to a third embodiment of the present invention. On a normally open fixed contact 6a is formed an inclined surface being of a convex shape and having an inclination angle θ. When a voltage is applied to a coil (not shown), the surface of the inclined movable contact 3a strikes the surface of the inclined surface of the normally open fixed contact 6a to come into physical contact. At this time point, a movable contact spring 3 bends with attractive forces of magnetic, which causes the movable contact 3a and the normally open fixed contact 6a to slide relatively on each other, and which the movable contact 3a is attracted to the normally open fixed contact 6a.

An electrical life test under lamp-loaded conditions was conducted, using a testing circuit shown in FIG. 7, on an electromagnetic relay having its contact configurations shown in FIG. 6 that was used as a test sample. An inclination angle θ which the surface of the movable contact 3a forms with the surface of the normally open fixed contact 6a was changed at every 5° from a level of θ=5° to a level of θ=45°. Ten test samples for each of the above inclination angle levels were prepared. Moreover, for comparison, another electrical life test was conducted, using the same circuit as used in the above test, on a test sample 1 having conventional contact structure shown in FIG. 3, that is, having its inclination angle θ=0° of the normally open fixed contact 6a. In this life test, both a coil voltage and a lamp-loaded voltage were 14 Vdc and the test was conducted in ordinary temperature environments and initial bounce time and the number of times of operations performed before an occurrence of failure were measured to obtain mean values.

As a result, almost the same effects obtained in the first and second embodiments were achieved in the third embodiment. Therefore, when the inclination angle θ of the inclined surface is more than 0° and is less than 45°, the occurrence of the initial bounce is prevented and the electromagnetic relay having an electrically long life can be obtained. The inclination angle θ is more preferably set to be more than 5° and 20° or less.

Moreover, even in cases other than the above embodiments, if the angle θ which the surface of the movable contact 3a forms with the surface of the normally open fixed contact 6a is substantially more than 0° and is less than 45°, the occurrence of the initial bounce is prevented and the electromagnetic relay having an electrically long life can be obtained. Moreover, setting the above angle θ to be more than 5° and 20° or less enables the electromagnetic relay having an electrically long life to be achieved.

It is apparent that the present invention is not limited to the above embodiments but may be changed and modified without departing from the scope and spirit of the invention. Additionally, by using the electromagnetic relay of the present invention, it is made possible to increase reliability of automobile parts and/or electrical components using electromagnetic relays.

What is claimed is:

1. An electromagnetic relay comprising:
a fixed contact member having a normally closed fixed contact;
a fixed contact member having a normally open fixed contact;
a movable contact spring having a movable contact whose surface is opposed to each of a surface of said normally closed fixed contact and a surface of said normally open fixed contact;
an armature coupled to said movable contact spring; and
an iron core around which coils used to attract said armature are wound;
wherein, by interaction between a spring force of said movable contact and a magnetic force generated by an exciting current fed to said coils, either of said normally closed fixed contact or said normally open fixed contact does or does not come into surface-contact with said movable contact and wherein an opposed angle θ, when viewed from a direction of sliding of said movable contact and said normally open fixed contact that is induced by bending of said normal contact spring, which said normally open fixed contact forms with said movable contact before either of said normal close contact or said normal open contact comes into surface-contact with said movable contact, is 0°<θ<45°.

2. The electro magnetic relay according to claim 1, wherein the opposed angle θ, when viewed from the direction of sliding of said movable contact and said normally open fixed contact that is induced by bending of said normal contact spring, which said normally open fixed contact forms with said movable contact before either of said normal close contact or said normal open contact comes into surface-contact with said movable contact, is 0°<θ<20°.

3. The electromagnetic relay according to claim 1, wherein said normally open fixed contact has a plate-shaped surface, and said movable contact has a plate-shaped surface.

4. The electromagnetic relay according to claim 1, wherein said normally open fixed contact is formed to have an inclination angle θ being equal to the opposed angle θ in advance, such that the opposed angle θ, when viewed from the direction of sliding of said movable contact and said normally open fixed contact that is induced by bending of said normal contact spring, which said normally open fixed contact forms with said movable contact before either of said normal close contact or said normal open contact comes into surface-contact with said movable contact, is 0°<θ<45°.

5. The electromagnetic relay according to claim 1, wherein said movable contact is formed to have an inclination angle θ being equal to the opposed angle θ in advance, such that the opposed angle θ, when viewed from the direction of sliding of said movable contact and said normally open fixed contact that is induced by bending of said normal contact spring, which said normally open fixed contact forms with said movable contact before either of said normal close contact or said normal open contact comes into surface-contact with said movable contact, is 0°<θ<45°.
